(19) United States
(12) Patent Application Publication
(10) Pub. No.: US 2021/0235679 A1
(43) Pub. Date: Aug. 5, 2021

(54) FISHING BOBBER AND METHOD OF ASSEMBLING THE SAME

(71) Applicants: Drew P. Taylor, Gilmanton, NH (US); Andrew P. TAYLOR, Gilmanton, NH (US)

(72) Inventors: Drew P. Taylor, Gilmanton, NH (US); Andrew P. TAYLOR, Gilmanton, NH (US)

(21) Appl. No.: 17/159,293

(22) Filed: Jan. 27, 2021

Related U.S. Application Data
(60) Provisional application No. 62/970,240, filed on Feb. 5, 2020.

(51) Int. Cl. A01K 93/00; A01K 91/04

(52) U.S. Cl. CPC A01K 93/00; A01K 91/04

(57) ABSTRACT

A fishing bobber comprising a three-dimensional or round body, a shaft in the center of the round body that forms a first aperture on a surface of the round body and a second aperture on the surface of the round body. At least one hook mechanism is configured to be received within the shaft. The hook mechanism has a hook portion that may releasably engage with the first aperture and a linehook portion that is configured to provide an anchor for a fishing line when secured to the fishing bobber. The linehook portion can be flat in shape so it is perpendicular to the shaft or curved in shape so that it has a same radius of curvature as the surface of the round body. The round body can be a golf ball, basketball, baseball, soccer ball, tennis ball, or other ball shape.

### FIELD OF THE DISCLOSURE

The present disclosure relates to fishing bobbers and more particularly to fishing bobbers and methods of making and assembling the same.

### BACKGROUND OF THE DISCLOSURE

A conventional fishing bobber, which sometimes referred to as a “fishing float,” is an article of fishing equipment that is generally secured to a fishing line and can serve several purposes. For example, the fishing bobber can be designed to suspend the bait on the end of the fishing line at a predetermined depth, can serve as a visual bite indicator, and is able to carry a baited hook to an otherwise inaccessible area of water due to its buoyancy. A conventional fishing bobber is comprised of a pair of circular hooks at each end of a shaft, biased inward by means of a spring. Each hook is received by a base integrated into the bobber and is spring-biased so that when the base is moved inward toward the center of the bobber, the hook is exposed, allowing a fishing line to be placed on the hook. This can be a difficult and oftentimes cumbersome procedure for both experienced and amateur fishermen and requires a great amount of hand dexterity. A conventional fishing bobber is also prone to breaking due to the hard plastic that is typically used, and if the base or any other portion, such as the spring, becomes even slightly damaged, the bobber no longer works. In a conventional spring-biased or spring-loaded bobber, if the hook becomes bent or otherwise damaged, the entire bobber must be replaced.

Wherefore it is an object of the present disclosure to overcome the above-mentioned shortcomings and drawbacks associated with the conventional fishing bobber.

### SUMMARY OF THE DISCLOSURE

An aspect of the present disclosure is a fishing bobber comprising: a round body; a shaft in a center of the round body that forms a first aperture on a surface of the round body; and at least one hook mechanism having a leg portion that releasably engages with the first aperture and a linehook portion that is configured to provide an anchor for a fishing line when secured to the fishing bobber.

One embodiment of the fishing bobber further comprises a second aperture formed on the surface of the round body, at an end of the shaft opposite the first aperture.

Another embodiment of the fishing bobber further comprises at least a second hook mechanism having a second linehook portion configured to releasably engage with the second aperture, and a second leg portion that releasably engages with the shaft.

In certain embodiments, the at least one linehook portion is flat in shape such that it is substantially perpendicular to the shaft. In other embodiments, the at least one linehook portion is curved in shape such that the linehook portion has approximately a same radius of curvature as the surface of the round body.

Yet another embodiment of the fishing bobber is wherein the surface of the round body forms a golf ball shape having a plurality of recesses thereon.

In some cases, the surface of the round body forms a basketball shape. In some cases, the surface of the round body forms a baseball shape.

Still yet another embodiment of the fishing bobber is wherein the at least one hook mechanism is configured to releasably engage with the shaft via a bias applied by the leg portion on an interior sidewall of the shaft. In certain embodiments, the fishing bobber is comprised of a buoyant material having a density less than that of water.

Another aspect of the present disclosure is a method of constructing a fishing bobber, the method comprising: providing a round body having a shaft in a center of the round body that forms a first aperture on a surface of the round body; and engaging a first hook mechanism through the first aperture on the round body to thereby engage a leg portion of the first hook mechanism with the shaft and such that a linehook portion of the hook mechanism thereby protrudes out of the first aperture.

One embodiment of the method further comprises: engaging a second hook mechanism through a second aperture on the surface of the round body so that a second leg portion of the second hook mechanism engages with the shaft and a second linehook portion of the second hook mechanism protrudes out of the second aperture.

Yet another aspect of the present disclosure is a fishing bobber comprising: a three-dimensional body; a shaft positioned in a center of the three-dimensional body and forms at least one aperture on a surface of the three-dimensional body; and wherein the shaft is configured to receive a hook mechanism having a linehook portion configured to anchor a fishing line and a leg portion configured to engage the shaft.

One embodiment of the fishing bobber is wherein the surface of the three-dimensional body forms a golf ball, a basketball, a baseball, or a soccer ball. In some cases, the surface of the three-dimensional body forms a football shape.

Another embodiment of the fishing bobber is wherein the three-dimensional body is spherical in shape.

Yet another embodiment of the fishing bobber is wherein the body is comprised of a molded plastic material.

In certain embodiments, the body is configured to stow the hook mechanism within the shaft when not in use as a fishing bobber. In some embodiments, the body is formed such that it is integral with the hook mechanism.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 is a front view of one embodiment of a fishing bobber according to the present disclosure;

FIG. 2 is a top view of the fishing bobber of FIG. 1;

FIG. 3 is a bottom view of the fishing bobber of FIG. 1;

FIG. 4 is a side view of a first, or “right,” side of the fishing bobber of FIG. 1;

FIG. 5 is a side view of a second, or “left,” side of the fishing bobber of FIG. 1;

FIG. 6 is a back view of the fishing bobber of FIG. 1;

FIG. 7 is a cross-sectional view as taken along line A-A of FIG. 2;

FIG. 7A is a partial cut-out view showing the engagement of a hook with the shaft of the round body of FIG. 7;

FIG. 8 is a front view of a fishing bobber according to the present disclosure having a basketball shaped body;

FIG. 9 is a perspective view of a first type of hook mechanism, according to the present disclosure;

FIG. 10 is a perspective view of a second type of hook mechanism, according to the present disclosure;

FIG. 11 is a perspective view of a third type of hook mechanism, according to the present disclosure;

FIG. 12 is a perspective view of a fourth type of hook mechanism, according to the present disclosure;

FIG. 13 is a perspective view of a fifth type of hook mechanism, according to the present disclosure;

FIG. 14 is a perspective view of a sixth type of hook mechanism, according to the present disclosure; and

FIG. 15 is a perspective view of a fishing line as engaged with one embodiment of a fishing bobber and looped through the linehook of the hook mechanism, according to the present disclosure.

### DETAILED DESCRIPTION OF THE DISCLOSURE

A fishing bobber according to the present disclosure comprises a three-dimensional body (generally round or circular) and a shaft traversing through a center of the round body that forms a first aperture on a surface of the round body and a second aperture on the surface of the body, opposite the first aperture. In certain embodiments, the shaft is configured to receive a hook mechanism that provides an anchor for a fishing line when secured to the fishing bobber. The shaft being configured to receive the hook mechanism allows for the hook mechanism to be releasably engaged with the shaft, such that the hook mechanism can be readily engaged with and released from the shaft. For example, this can be particularly useful if desirable, for example, to utilize the fishing bobber for other activities, such as also using the fishing bobber as a golf ball as a second activity. A conventional fishing bobber would not be able to be utilized as a golf ball because it would not roll effectively due to the base and hook that extend outward from the fishing bobber. For example, by using a golf ball shaped bobber according to the present disclosure, a user can simply release the hook mechanism from the shaft of the fishing bobber to be able to utilize the fishing bobber as a conventional golf ball (or other type of ball). One significant advantage of this feature is that the golf ball would float, so it would be easier to retrieve, for example, if the golf ball were hit into a body of water. In another example, the fishing bobber can also be formed of a bouncy material so that the bobber could be used as a bouncy ball for the second activity.

It will be appreciated that in certain embodiments, the hook mechanisms are permanently secured within the shaft such that they are not releasably engaged, but rather permanently engaged. The bobber could thus be used in a second activity with the hook mechanisms still engaged or could be used for the single activity of a fishing bobber. In some instances, the bobber may have a generally round shape and may be configured to be used as a simple ball in the second activity for the bobber.

Referring to FIG. 1, a front view of one embodiment of a fishing bobber 100 according to the present disclosure is shown. The fishing bobber 100 includes a three-dimensional body 110, a first hook mechanism 120, a second hook mechanism 122, a first aperture 130, and a second aperture 132. A central hollow tube or shaft (not shown in FIG. 1) in the center of the round body 110 forms the first aperture 130 on an exterior surface of the round body 110 and the second aperture 132, also on the exterior surface of the round body 110, opposite the first aperture 130. Refer to shaft 140 shown in FIG. 7 for a detailed depiction of the central shaft that runs through the center of the round body 110.

The three-dimensional body 110 may be generally referred to as a “round body” herein, however it will be understood that the round body 110 can be any appropriate three-dimensional shape. In this example, the round body 110 has a golf ball shape as denoted by golf ball shaped recesses 112. It will be appreciated that other shapes can be implemented within ordinary skill, such as a basketball (shown in FIG. 8), a baseball, a lacrosse ball, a tennis ball, a soccer ball, a football, and the like. It will further be appreciated that although sports shapes are generally shown for the round body 110, other shapes can be implemented, or can be omitted so that only a simple round body 110 is provided with no markings thereon. Generally, any three-dimensional shape can be implemented that is capable of being buoyant when molded or cast in the appropriate material.

It should be apparent that the bobber can easily be assembled by snapping or otherwise securing the hook mechanism(s) 120, 122 into engagement through the aperture(s) 130, 132 when desired to use as a bobber. Yet, the hook mechanism(s) 120, 122 can easily be removed or otherwise disengaged from the aperture(s) 130, 132 when desired to be used as a ball instead of a bobber. The hook mechanism(s) 120, 122 can be considered to be releasably engaged with respect to the aperture(s) 130, 132, and/or the shaft 140. As used herein “releasably engaged” is intended to mean that the hook mechanisms in one configuration are engaged with the body portion 110 yet can be moved into a released position where the hook mechanisms are not engaged with the body portion 110. In some instances, the hook mechanism(s) 120, 122 may be permanently affixed to the round body 110. In certain embodiments, the hook mechanism(s) 120, 122 can be stowed within the shaft 140 when desired to be used as a ball instead of a bobber.

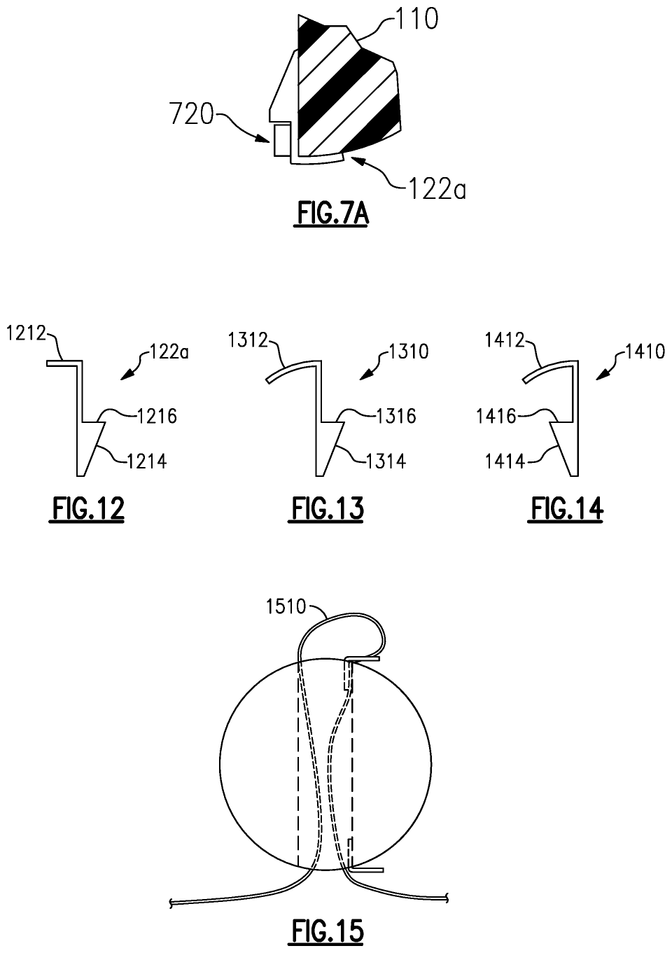

The hook mechanisms 120, 122, which are shown in greater detail in FIG. 9 and alternate examples in FIGS. 10-11, are shown engaged within the first aperture 130 and the second aperture 132, respectively in FIG. 1. Refer, for example, to FIG. 7 showing the hook mechanisms 120, 122 through each aperture 130, 132, respectively, and engaged within the shaft 140. The hook mechanisms 120, 122 are for anchoring a fishing line to the fishing bobber. Although two hook mechanisms 120, 122 are shown, only one hook mechanism may be implemented in some instances.

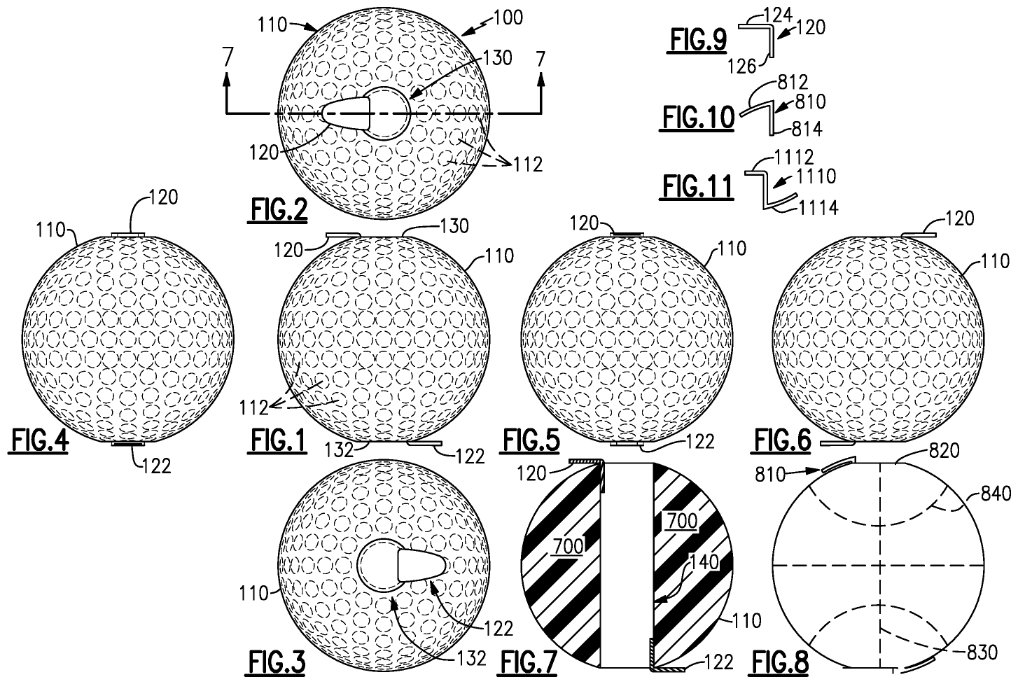

FIG. 2 is a top view of the fishing bobber of FIG. 1. As shown, the hook mechanism 120 is engaged within the aperture 130. FIG. 3 is a bottom view of the fishing bobber of FIG. 1. As shown, the hook mechanism 122 is engaged within the aperture 132. FIG. 4 is a side view of a first, or “right,” side of the fishing bobber of FIG. 1, showing the round body 110, the first hook mechanism 120, and the second hook mechanism 122. FIG. 5 is a side view of a second, or “left,” side of the fishing bobber of FIG. 1, showing the round body 110, the first hook mechanism 120, and the second hook mechanism 122. The second side is generally opposite the first side shown in FIG. 4. FIG. 6 is a back or “rear” view of the fishing bobber of FIG. 1, showing the round body 110, the first hook mechanism 120, and the second hook mechanism 122. The rear view is generally opposite the front view shown in FIG. 1.

FIG. 7 is a cross-sectional view as taken along line A-A of FIG. 2. The central shaft or tube 140 is visible, which forms the first aperture 130 and second aperture 132 on the surface of the body. Note that the first hook mechanism 120 is engaged within the aperture 130. Refer to FIG. 9 showing the hook mechanism 120 in greater detail. A leg portion 126 (see FIG. 9) of the hook mechanism 120 is engaged with a sidewall of the shaft 140. Likewise, the second hook mechanism 122 is engaged within the aperture 132 such that a leg portion of the hook mechanism 122 is engaged with a sidewall of the shaft 140. The linehook portion (124) of each hook mechanism is extending outwardly from the aperture in a direction generally perpendicular to the shaft 140. In certain embodiments, the linehook portion (124) of each hook mechanism extends outwardly from the aperture in a direction generally tangential to the outer surface of the body 110.

The central shaft 140 provides a hollow tube through the round body 110 and thereby forms a body cavity 700 that is airtight to the exterior. The body cavity 700 can be filled with air or can be a solid material, depending upon the particular application or second activity to be implemented with the fishing bobber. For example, the round body 110 could be a hard plastic, or high-density polyurethane (HDPE). The hook mechanism 120, 122 could be any appropriate metal material, such as aluminum or brass, or a hard plastic material. The shaft 140 could be any hard plastic or could be a hole formed in a contiguous body 110 so that the shaft 140 is effectively the same material as the round body 110 and the body cavity 700 to form a solid material with the hollow shaft 140 therethrough.

FIG. 7A is a partial cut-out view showing the engagement of a hook mechanism with the shaft of the round body of FIG. 7. As shown in greater detail in FIG. 7A, and also with reference to FIG. 13 showing the hook 122a in greater detail, the hook mechanism 122a engaged with the main body 110. Note that the hook mechanism 122a includes the leg portion 1214 that defines a barb and having a flattened edge 1216. In certain embodiments, the flattened edge 1216 engages with a lip 720, or the like, on the shaft 140 of the main body 110. This engagement secures the hook mechanism 122a within the shaft 140, while allowing the hook mechanism to be removed from the shaft 140 when sufficient pressure is applied outwardly to remove the hook mechanism from the shaft, thereby releasably engaging the hook mechanism within the shaft, through the aperture.

FIG. 8 is a front view of a fishing bobber according to the present disclosure having a basketball shaped body. Note that in this embodiment, the hook mechanism 810 is curved in shape at the linehook portion (812) so that the hook mechanism and the round body have a same radius of curvature, while still allowing an opening having a minimal gap for fishing line to be fed therethrough for securing the bobber to the line. In this implementation, a first aperture 820 is shown as well as a second aperture 830. The first aperture 820 receives the first hook mechanism 810, and in this example the second aperture 830 does not have a hook mechanism. It will be appreciated that the second aperture 830 can also include a second hook mechanism (not shown) if so desired by the user.

Reference is now made to FIGS. 9-14 illustrating various example types of hook mechanisms that can be implemented according to the present disclosure. These should be exemplary only and not limiting of hook mechanisms that can be utilized by the disclosure. It should be apparent that any appropriate hook mechanism can be provided that anchors a flat or curved hook member within the shaft. It should further be appreciated that any hook mechanism structure can be implemented so long as there is a portion that extends from the aperture to engage a fishing line (generally the “linehook portion” herein) and another portion within and through the aperture that engages with the shaft in the main body (generally the “leg portion” herein). The hook mechanism can be any appropriate clip, holder, fastener, anchor, or clasp, in accordance with the present disclosure. It should still further be appreciated that a hook mechanism may include a relatively straight leg portion, as shown in FIGS. 9-10, or may have a curved protrusion as depicted in FIG. 11 or may have a barbed shape as shown in FIGS. 12-14 that engaged with a lip on an interior of the shaft. As noted previously, it may also be possible to have a hook mechanism that is integral to the body, where the line hook may be stowed internally when being used for a second purpose or during shipment.

FIG. 9 is a perspective view of the hook mechanism 120, depicting a first type of hook mechanism, according to the present disclosure. The linehook portion 124 is generally flat and perpendicular with respect to the shaft 140, for example as shown in FIG. 7.

FIG. 10 is a perspective view of a second type of hook mechanism, according to the present disclosure. The hook mechanism 810 can be the same as the hook mechanism depicted in FIG. 8 and could be used in combination or instead of any of the other hook mechanisms shown and described herein. The hook mechanism 810 includes a linehook portion 812 and a leg portion 814. The linehook portion 812 is configured to anchor a fishing line to the bobber. The leg portion 814 is for engaging with the shaft in the main body.

FIG. 11 is a perspective view of a third type of hook mechanism, according to the present disclosure. The hook mechanism 1110 includes a linehook portion 1112 and a leg portion 1114. The linehook portion 1112 is configured to anchor a fishing line to the bobber. The leg portion 1114 is for engaging with the shaft in the main body.

FIG. 12 is a perspective view of a fourth type of hook mechanism, according to the present disclosure. The hook mechanism 122a, which may be the same as or substantially similar to the hook mechanism depicted in FIG. 7A, includes a flat linehook portion 1212, a leg portion 1214 forming a barb, and having a flattened surface 1216. This flattened surface 1216 can be configured to engage with a lip, or the like, on the interior of the shaft 140 of the main body 110. The linehook portion 1212 can be flat as shown in FIG. 12 or can be curved as show in FIG. 13.

FIG. 13 is a perspective view of a fifth type of hook mechanism, according to the present disclosure. The hook mechanism 1310 includes a linehook portion 1312 which is curved in this example. The hook mechanism 1310 includes a leg portion 1314 forming a barb and having a flattened surface 1316. This flattened surface 1316 can be configured to engage with a lip on the interior of the shaft 140 of the main body 110.

FIG. 14 is a perspective view of a sixth type of hook mechanism, according to the present disclosure. The hook mechanism 1410 is similar to the hook mechanism 1310, except that the barb portion extends in the opposite direction. The hook mechanism 1410 includes a linehook portion 1412 that is curved in this example but may be flat in other configurations. The hook mechanism 1410 includes a leg portion 1414 that forms a barb and having a flattened surface 1416. This flattened surface 1416 can be configured to engage with a lip on the interior of the shaft 140 of the main body 110.

FIG. 15 is a perspective view of a fishing line as engaged with one embodiment of a fishing bobber of the present disclosure and looped through the linehook of the hook mechanism. As shown, the fishing line 1510 can be passed upward through the shaft 140, looped around the linehook portion of the hook mechanism, and then passed down through the shaft 140, thereby securing the fishing bobber to the fishing line. Note that in this example, only the top hook mechanism is secured to the fishing line 1510, however both hooks may be secured to the fishing line 1510 if desired by a particular user.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. A fishing bobber comprising:
a round body;
a shaft in a center of the round body that forms a first aperture on a surface of the round body; and
at least one hook mechanism having a leg portion that releasably engages with the first aperture and a linehook portion that is configured to provide an anchor for a fishing line when secured to the fishing bobber.

2. The fishing bobber of claim 1, further comprising a second aperture formed on the surface of the round body, at an end of the shaft opposite the first aperture.

3. The fishing bobber of claim 2, further comprising at least a second hook mechanism having a second linehook portion configured to releasably engage with the second aperture, and a second leg portion that releasably engages with the shaft.

4. The fishing bobber of claim 1, wherein the at least one linehook portion is flat in shape such that it is substantially perpendicular to the shaft.

5. The fishing bobber of claim 1, wherein the at least one linehook portion is curved in shape such that the linehook portion has approximately a same radius of curvature as the surface of the round body.

6. The fishing bobber of claim 1, wherein the surface of the round body forms a golf ball shape having a plurality of recesses thereon.

7. The fishing bobber of claim 1, wherein the surface of the round body forms a basketball shape.

8. The fishing bobber of claim 1, wherein the surface of the round body forms a baseball shape.

9. The fishing bobber of claim 1, wherein the at least one hook mechanism is configured to releasably engage with the shaft via a bias applied by the leg portion on an interior sidewall of the shaft.

10. The fishing bobber of claim 1, wherein the fishing bobber is comprised of a buoyant material having a density less than that of water.

11. A method of constructing a fishing bobber, the method comprising:
providing a round body having a shaft in a center of the round body that forms a first aperture on a surface of the round body; and
engaging a first hook mechanism through the first aperture on the round body to thereby engage a leg portion of the first hook mechanism with the shaft and such that a linehook portion of the hook mechanism thereby protrudes out of the first aperture.

12. The method of claim 11, further comprising:
engaging a second hook mechanism through a second aperture on the surface of the round body so that a second leg portion of the second hook mechanism engages with the shaft and a second linehook portion of the second hook mechanism protrudes out of the second aperture.

13. A fishing bobber comprising:
a three-dimensional body;
a shaft positioned in a center of the three-dimensional body and forms at least one aperture on a surface of the three-dimensional body; and
wherein the shaft is configured to receive a hook mechanism having a linehook portion configured to anchor a fishing line and a leg portion configured to engage the shaft.

14. The fishing bobber of claim 13, wherein the surface of the three-dimensional body forms a golf ball, a basketball, a baseball, or a soccer ball.

15. The fishing bobber of claim 13, wherein the surface of the three-dimensional body forms a football shape.

16. The fishing bobber of claim 13, wherein the three-dimensional body is spherical in shape.

17. The fishing bobber of claim 13, wherein the body is comprised of a molded plastic material.

18. The fishing bobber of claim 13, wherein the body is configured to stow the hook mechanism within the shaft when not in use as a fishing bobber.

19. The fishing bobber of claim 13, wherein the body is formed such that it is integral with the hook mechanism.
